(19) United States
(12) Patent Application Publication
(10) Pub. No.: US 2023/0021977 A1
(43) Pub. Date: Jan. 26, 2023

(54) WIRELESS SYSTEM, RECEIVING RELAY STATION DEVICE AND TRANSMITTING CONTROL METHOD

(71) Applicant: NIPPON TELEGRAPH AND TELEPHONE CORPORATION, Tokyo (JP)

(72) Inventors: Daisuke GOTO, Musashino-shi, Tokyo (JP); Fumihiro YAMASHITA, Musashino-shi, Tokyo (JP); Kiyohiko ITOKAWA, Musashino-shi, Tokyo (JP); Yasuyoshi KOJIMA, Musashino-shi, Tokyo (JP)

(73) Assignee: NIPPON TELEGRAPH AND TELEPHONE CORPORATION, Tokyo (JP)

(21) Appl. No.: 17/787,628

(22) PCT Filed: Dec. 23, 2019
(86) PCT No.: PCT/JP2019/050386

§ 371 Date: Jun. 21, 2022

(51) Int. Cl. H04B 7/185; H04B 7/195

(52) U.S. Cl. CPC H04B 7/18513; H04B 7/195

(57) ABSTRACT

In a radio system including: a plurality of transmitting station devices; a receiving relay station device for relaying radio signals transmitted by the transmitting station devices; and a receiving station device for receiving the radio signals relayed by the receiving relay station device, with a first transmission capacity between the receiving relay station device and the receiving station device varying, the receiving relay station device performs control to cause the transmitting station devices to transmit the radio signals if the first transmission capacity is greater than or equal to a predetermined value. With this configuration, a lack of information can be prevented even if the transmission capacity between the receiving relay station device and the receiving station device varies.

### TECHNICAL FIELD

The present invention relates to a transmission control technique for use when a plurality of transmitting station devices transmit information that does not require immediacy to a receiving station device via a receiving relay station device in a radio system that includes the plurality of transmitting station devices, the receiving relay station device for relaying radio signals transmitted by the transmitting station devices, and a receiving station device for receiving the radio signals relayed by the receiving relay station device.

### BACKGROUND ART

In the case of radio systems that use communication satellites, low earth orbit satellites (LEO: Low Earth Orbit) that travel around low orbits with an altitude of about 1000 km have a shorter propagation distance than geostationary satellites (GEO: GEostationary Orbit) that orbit at an altitude of 36,000 km, and can therefore realize low delay and low propagation loss and makes it easier to configure high-frequency circuits of communication satellites and terminal devices. However, in the case of the low earth orbit satellites, the direction of a satellite seen from a terminal device on the ground constantly changes, and the visibility time is a few minutes per orbit, limiting the time period when communication is possible, unlike the geostationary satellites.

Meanwhile, IoT (Internet of Things) systems are becoming widespread that connect small terminal devices to the Internet and realize various applications. As an application example of IoT systems, a service is known in which IoT terminals installed at a plurality of locations sense environmental information, such as air temperature, room temperature, acceleration, and luminosity, and transmits the sensed environmental information using radio signals, and the cloud side collects the environmental information. In addition, LPWA (Low Power Wide Area) is known as a system that enables wide-area communication with low power and at a low transmission rate that are suitable for communication with IoT terminals. Although the propagation distance is longer in satellite communication than in terrestrial radio, there is a possibility that LPWA can be applied to low earth orbit satellites, and satellite IoT systems that directly collect data from IoT terminals using LPWA by means of satellite communication has been studied.

Such satellite IoT systems make IoT available in aviation, shipping, and rural areas that cannot be accommodated by ordinary LPWA, and make it easy to expand services since such systems do not use hub stations. However, since a satellite IoT system needs to accommodate IoT terminals in a wide area, it is necessary to increase the capacity of feeder links (lines that bilaterally connect base station devices to a satellite) for transmitting data collected from a plurality of IoT terminals by the communication satellite to the base station device. As a method for increasing the capacity of the feeder links, a satellite MIMO (Multi-Input Multi-Output) method using a plurality of transmitting-receiving antennas has been studied. In communication (MIMO transmission) using the MIMO method, it is required for the channels of the transmitting-receiving antennas to have low correlation in order to increase the capacity. However, in the case of a communication satellite, direct waves are the dominant channel and the propagation distance is much greater than the distance between the antennas, and therefore, MIMO transmission with a plurality of antennas provided in the communication satellite has a problem in that the channel correlation is high, making it difficult to increase the capacity. For this reason, the increase in the capacity in satellite MIMO transmission needs to be studied in order to accommodate a large number of IoT terminals in a satellite IoT system.

For example, when the MIMO method is used in service links of a multi-beam satellite, a technique of performing precoding using channel estimation information that is fed back from user terminals in order to reduce interference between beams all of which are allocated to the same frequency, is known (e.g., see NPL 1).

Further, in feeder link MIMO transmission in the case where a low earth orbit satellite and a base station device both have two antennas, it is known that the transmission capacity varies due to variations in the distance between the antennas (e.g., see NPL 2).

### CITATION LIST

### [Non Patent Literature]

[NPL 1] G. Gallinaro, G. Caire, M. Debbah, L. Cottatellucci, R. Muller, R. Rinaldo, “Perspectives of adopting interference mitigation techniques in the context of broadband multimedia satellite systems”, in 23rd AIAA Int. Commun. Satell. Syst. Conf., ICSSC2005, September 2005.

[NPL 2] Chihaya Kato, Mitsuhiro Nakadai, Daisuke Goto, HirokiShibayama, and Fumihiro Yamashita, “Channel Capacity Analysis of LEO MIMO System Considering the Satellite Attitude”, IEICE Technical Report, SAT 2019-24, pp. 39-44, August 2019.

### SUMMARY OF THE INVENTION

### Technical Problem

However, the technique of NPL 1 requires that there is no substantial channel variation occurs during the time from feedback from a user terminal to the precoding and transmission, as in a communication system that uses a geostationary satellite, and therefore, a communication system that uses a low earth orbit satellite with which variation occurs from moment to moment has a problem in that performance of reducing interference deteriorates.

In the technique of NPL 2, a reduction in the transmission capacity of feeder links is a bottleneck, and thus, there is a problem in that information is lost due to the reduction in the transmission capacity when, for example, information transmitted from an IoT terminal to a low earth orbit satellite relay is transmitted over the feeder links.

An object of the present invention is to provide a radio system, a receiving relay station device, and a transmission control method with which a loss of information can be prevented even if the transmission capacity between a receiving relay station device and a receiving station device varies in a radio system in which a plurality of transmitting station devices transmit information that does not require immediacy to the receiving station device via the receiving relay station device.

### Means for Solving the Problem

The present invention is a radio system including: a plurality of transmitting station devices; a receiving relay station device for relaying radio signals transmitted by the transmitting station devices; and a receiving station device for receiving the radio signals relayed by the receiving relay station device, with a first transmission capacity between the receiving relay station device and the receiving station device varying, wherein the receiving relay station device performs control to cause the transmitting station devices to transmit the radio signals if the first transmission capacity is greater than or equal to a predetermined value.

The present invention is a receiving relay station device that relays radio signals transmitted by a plurality of transmitting station devices and transmits the relayed radio signals to a receiving station device, the receiving relay station device including: a receiving unit for receiving, from the receiving station device, a first transmission capacity between the receiving relay station device and the receiving station device, the first transmission capacity varying; and a comparison unit for performing control to cause the plurality of transmitting station devices to transmit the radio signals if the first transmission capacity is greater than or equal to a predetermined value.

The present invention is a transmission control method for controlling transmission timing of a plurality of transmitting station devices in a radio system in which a receiving relay station device relays radio signals transmitted by the transmitting station devices and transmits the relayed radio signals to a receiving station device, the method including performing control to cause the plurality of transmitting station devices to transmit the radio signals if a first transmission capacity between the receiving relay station device and the receiving station device, the first transmission capacity varying, is greater than or equal to a predetermined value, with use of the receiving relay station device.

### Effects of the Invention

The radio system, the receiving relay station device, and the transmission control method according to the present invention make it possible to prevent a loss of information even if the transmission capacity between the receiving relay station device and the receiving station device varies in the radio system in which a plurality of transmitting station devices transmit information that does not require immediacy to the receiving station device via the receiving relay station device.

### BRIEF DESCRIPTION OF DRAWINGS

FIG. 1 is a diagram showing an example of a radio system according to a first embodiment.

FIG. 2 is a diagram showing an example configuration in the case where the radio system is a satellite IoT system.

FIG. 3 is a diagram showing an example of transmission capacity in the radio system according to the first embodiment.

FIG. 4 is a diagram showing an example of variations in the transmission capacity in the case where a receiving relay station device according to a second embodiment is a low earth orbit satellite.

FIG. 5 is a diagram showing an example of a radio system according to a third embodiment.

FIG. 6 is a diagram showing an example of variations in the transmission capacity of a receiving relay station device according to the third embodiment.

FIG. 7 is a diagram showing an example where the receiving relay station device notifies communicable time for each area.

FIG. 8 is a diagram showing an example of a radio system according to a fourth embodiment.

FIG. 9 is a diagram showing an example of variations in the transmission capacity of two receiving relay station devices.

FIG. 10 is a diagram showing an example where a plurality of receiving relay station devices notify respective communicable time.

FIG. 11 is a diagram showing an example configuration of a transmitting station device.

FIG. 12 is a diagram showing an example configuration of a receiving relay station device.

FIG. 13 is a diagram showing an example configuration of a receiving station device.

FIG. 14 is a diagram showing an example of an operation sequence of the radio system.

### DESCRIPTION OF EMBODIMENTS

Hereinafter, embodiments of a radio system, a receiving relay station device, and a transmission control method according to the present invention will be described with reference to the drawings.

First Embodiment

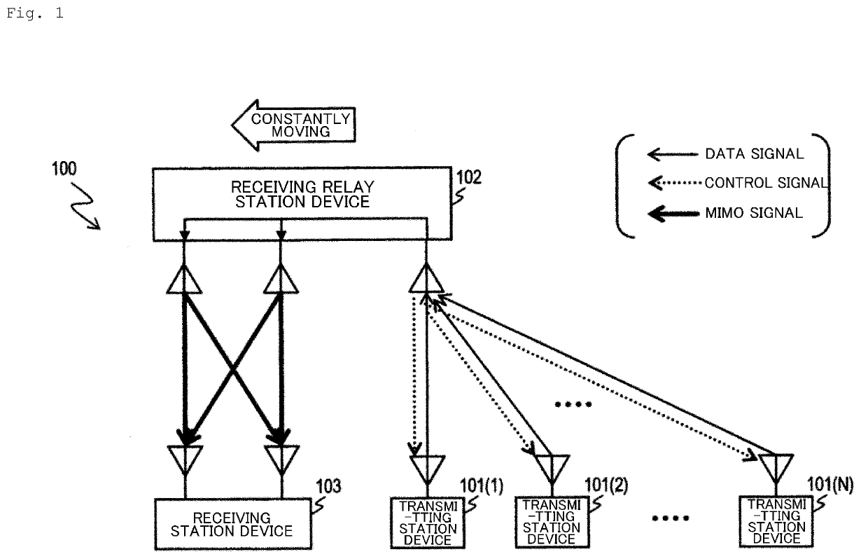

FIG. 1 shows an example of a radio system 100 according to the first embodiment. In FIG. 1, the radio system 100 has N (N is a positive integer) transmitting station devices 101, which are a transmitting station device 101(1), a transmitting station device 101(2), . . . , and a transmitting station device 101(N), a receiving relay station device 102, and a receiving station device 103. Here, in the following description, the transmitting station devices 101(1) to 101(N) are referred to as transmitting station devices 101 without the number in parentheses following the reference numeral when a description common to the transmitting station devices 101 (1) to 101 (N) is given. The same applies to the other blocks.

In FIG. 1, the plurality of transmitting station devices 101 transmit and receive radio signals (data signals/control signals) to and from the receiving relay station device 102. The receiving relay station device 102 is a mobile body that constantly moves, relays the data signals received from the plurality of transmitting station devices 101, and transmits the data signals to the receiving station device 103 by means of spatially-multiplexed transmission using the MIMO method. The receiving relay station device 102 and the receiving station device 103 each have a plurality of antennas (two antennas in FIG. 1) for performing MIMO transmission. In FIG. 1, solid arrows and dotted arrows indicate the data signals and the control signals, respectively. Note that the data signals and the control signal will be described later in detail.

Here, a description will be given of a specific example in the case where the radio system 100 is used as a satellite IoT system 100.

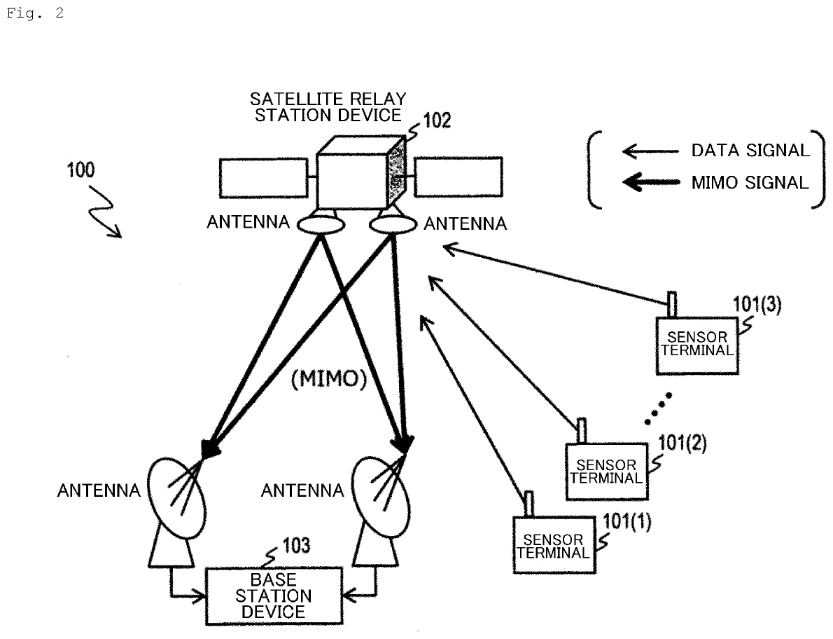

FIG. 2 shows an example configuration in the case where the radio system 100 is the satellite IoT system 100. In FIG. 2, the satellite IoT system 100 has N sensor terminals 101, which are a sensor terminal 101(1), a sensor terminal 101(2), . . . , and a sensor terminal 101 (N) , a satellite relay station device 102, and a base station device 103.

The sensor terminals 101 correspond to the transmitting station devices 101 in FIG. 1, sense environmental information, such as air temperature, room temperature, acceleration, and luminosity, and transmit the sensed environmental information to the satellite relay station device 102, for example. The information sensed by the sensor terminals 101 is log data, and can be transmitted at any time since it is not information that needs to be transmitted in real time. For example, the sensor terminals 101 transmit, to the satellite relay station device 102, information sensed at the time at which the sensor terminals 101 can communicate with the satellite relay station device 102. Note that transmission from the sensor terminals 101 to the satellite relay station device 102 is performed using a multiple access method.

The satellite relay station device 102 corresponds to the receiving relay station device 102 in FIG. 1, and a low earth orbit satellite is used thereas, for example. The satellite relay station device 102 receives the data signals that includes sensing information from the plurality of sensor terminals 101, and transmits the received data signals to the base station device 103 by means of regenerative relay or non-regenerative relay.

The base station device 103 corresponds to the receiving station device 103 in FIG. 1, demodulates the data signals received from the satellite relay station device 102 to sensing information and records the demodulated information. The base station device 103 can thus collect the sensing information from the plurality of sensor terminals 101.

The satellite relay station device 102 and the base station device 103 each have two antennas, and performs spatially-multiplexed transmission using the MIMO method in which different signals are transmitted between the antennas. Note that, for example, channels with different frequencies are used in the communication between the sensor terminals 101 and the satellite relay station device 102 and between the satellite relay station device 102 and the base station device 103.

Here, although FIG. 2 shows a specific example of the sensor terminals 101 that sense environmental information, these terminals do not need to be the sensor terminals 101, and any devices that regularly transmit information that does not need to be transmitted in real time can be applied. Similarly, any mobile body that constantly moves and relays information transmitted from the plurality of transmitting station devices 101, rather than a low earth orbit satellite, can be similarly applied as the satellite relay station device 102.

The embodiments in FIG. 1 and the subsequent diagrams will be described while generalizing the sensor terminals 101, the satellite relay station device 102, and the base station device 103 as the transmitting station devices 101, the receiving relay station device 102, and the receiving station device 103, respectively.

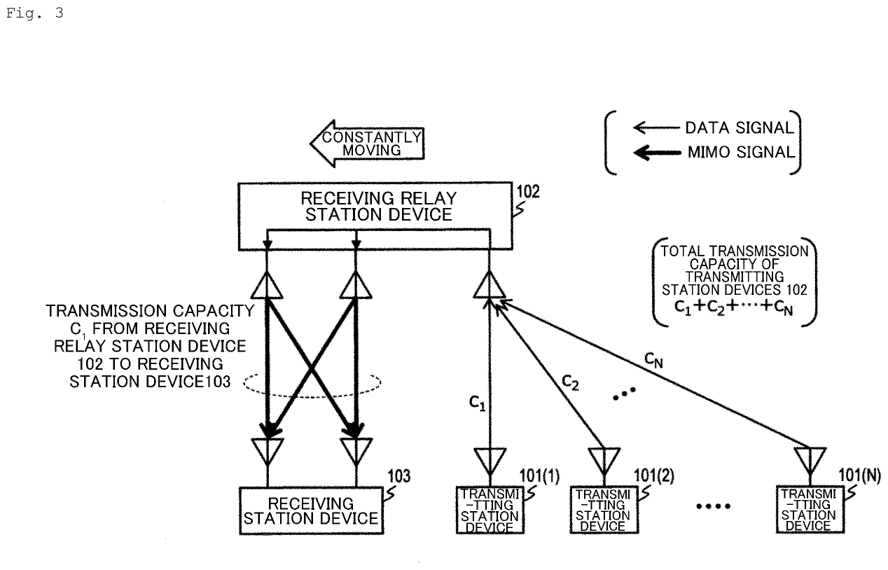

FIG. 3 shows an example of the transmission capacity of the radio system 100 according to the first embodiment. Note that the radio system 100 shown in FIG. 3 is the same as the radio system 100 shown in FIG. 1.

In FIG. 3, since the receiving relay station device 102 is constantly moving, the correlation between the antennas of the receiving relay station device 102 and the receiving station device 103 changes. For example, the higher the correlation between the antennas, the lower the transmission capacity between the receiving relay station device 102 and the receiving station device 103, and conversely, the lower the correlation between the antennas, the higher the transmission capacity. The receiving relay station device 102 can determine whether or not communication can be performed without a loss of information, in accordance with whether or not the transmission capacity between the receiving relay station device 102 and the receiving station device 103 is greater than or equal to the total transmission capacity of the plurality of transmitting station devices 101 (hereinafter referred to as total transmission capacity (which corresponds to a first transmission capacity)).

For example, in FIG. 3, when the transmission capacity from the transmitting station device 101(1) to the receiving relay station device 102 is c₁ [bps], the transmission capacity from the transmitting station device 101(2) to the receiving relay station device 102 is c₂ [bps], . . ., and the transmission capacity from the transmitting station device 101(N) to the receiving relay station device 102 is c_{N} [bps], the total transmission capacity Cₛ of all the transmitting station devices 101 is expressed by an equation (1).

Cₛ=c₁i+c₂+ . . . +c_{N} (1)

Here, since the transmission capacity (which corresponds to a second transmission capacity) C₁ [bps] from the receiving relay station device 102 to the receiving station device 103 varies in accordance with the correlation between the transmitting-receiving antennas for the MIMO transmission, the following two states occur depending on the movement of the receiving relay station device 102.

C₁≥Cₛ (2)

C₁<Cₛ (3)

When the inequality (2) is satisfied, the transmission capacity C₁ from the receiving relay station device 102 to the receiving station device 103 is greater than or equal to the total transmission capacity Cₛ of the transmitting station devices 101, and therefore, data signals transmitted from all the transmitting station devices 101 are relayed without a loss by the receiving relay station device 102, and are transmitted from the receiving relay station device 102 to the receiving station device 103.

On the other hand, when the inequality (3) is satisfied, the transmission capacity C₁ from the receiving relay station device 102 to the receiving station device 103 is smaller than the total transmission capacity Cₛ of the transmitting station devices 101, and therefore, there is a possibility that the data signals transmitted from all the transmitting station devices 101 are not appropriately relayed from the receiving relay station device 102 to the receiving station device 103, resulting in congestion and a loss of information. Note that, in the determination of the inequalities (2) and (3), for example, a value (predetermined value) obtained by adding a margin a to Cₛ may be compared with C₁. Alternatively, an upper limit value of the total transmission capacity Cₛ of the plurality of transmitting station devices 101 may be determined at the system design stage of the radio system 100, and this upper limit value may be used as a predetermined value and compared with C₁. In this case, since the total transmission capacity Cₛ of the plurality of transmitting station devices 101 does not exceed the predetermined value, each transmitting station device 101 does not need to notify the receiving relay station device 102 of its transmission capacity in the later-described embodiments. For this reason, the receiving relay station device 102 does not need to calculate the total transmission capacity Cₛ from the transmission capacity notified by the transmitting station devices 101.

The receiving relay station device 102 in the radio system 100 according to the first embodiment transmits a control signal for permitting transmission of the data signals to the transmitting station devices 101 if the inequality (2) is satisfied (communication permission notification) , and transmits a control signal for stopping transmission of the data signals to the transmitting station devices 101 if the inequality (3) is satisfied (communication stop notification). Note that the communication permission notification and the communication stop notification are simultaneously given for the plurality of transmitting station devices 101.

Thus, in the radio system 100 according to the first embodiment, even if the transmission capacity between the receiving relay station device 102 and the receiving station device 103 varies, the receiving relay station device 102 controls the transmission timing at which the transmitting station devices 101 transmit the data signals, in accordance with the variations in the transmission capacity between the receiving relay station device 102 and the receiving station device 103. Accordingly, the receiving relay station device 102 can transmit the data signals of the plurality of transmitting station devices 101 to the receiving station device 103 without a loss of information.

Note that each transmitting station device 101 notifies the receiving relay station device 102 that is checked using a beacon signal constantly transmitted therefrom, of an access request for transmitting a data signal and the transmission capacity of the data signal. The receiving relay station device 102 can thus acquire the transmission capacity of the data signal transmitted from each transmitting station device 101. Further, the receiving station device 103 calculates the transmission capacity of a MIMO signal between the receiving relay station device 102 and the receiving station device 103 based on a pilot signal received from the receiving relay station device 102, and notifies the receiving relay station device 102 of the calculated transmission capacity. Note that the pilot signal is a signal known to both the receiving relay station device 102 and the receiving station device 103.

[Second Embodiment]

Next, the radio system 100 according to the second embodiment will be described. The second embodiment has the same configuration as the first embodiment, whereas the receiving relay station device 102 is a low earth orbit satellite in the second embodiment.

When the receiving relay station device 102 is a low earth orbit satellite, the orbit and the speed of the satellite serve as parameters that are periodic to some extent, and therefore the receiving relay station device 102 can acquire, in advance, the variations in the transmission capacity C₁. In the present embodiment, the receiving relay station device 102 notifies the transmitting station devices 101 of a time period during which the transmission capacity C₁ exceeds a predetermined value as communicable time. With this configuration, the transmitting station devices 101 transmit data signals only during that time period, and thus, the control of the communication permission notification or the communication stop notification does not need to be performed in accordance with the variations in the transmission capacity C₁ as in the first embodiment. Note that it is assumed that the transmission capacity of each transmitting station device 101 is fixed and the total transmission capacity Cₛ of the plurality of transmitting station devices 101 does not change.

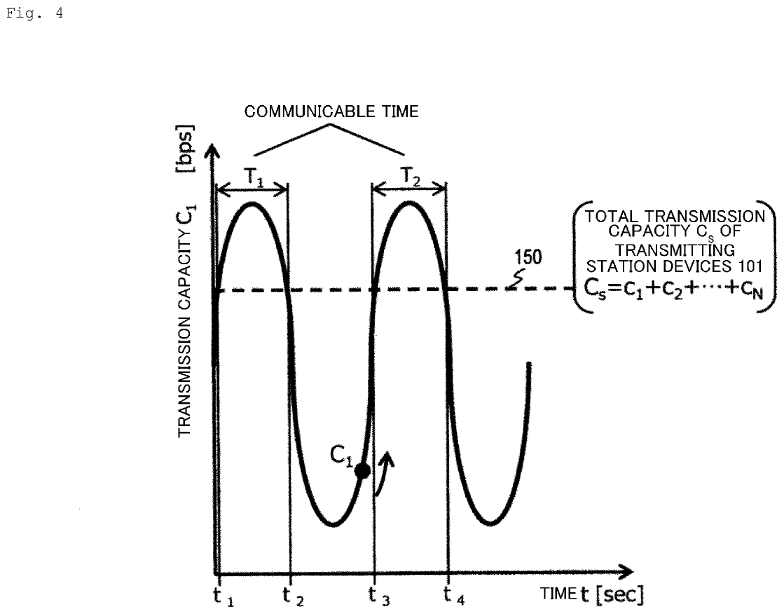

FIG. 4 shows an example of variations in the transmission capacity C₁ in the case where the receiving relay station device 102 is a low earth orbit satellite. In FIG. 4, the horizontal axis and the vertical axis indicate time t [sec] and the transmission capacity C₁ [bps] from the receiving relay station device 102 to the receiving station device 103, respectively.

Since the receiving relay station device 102 is constantly moving in a periodic orbit, the transmission capacity C₁ between the receiving relay station device 102 and the receiving station device 103 varies as shown in FIG. 4. Here, similarly to the receiving relay station device 102 of the first embodiment, the receiving relay station device 102 can determine whether or not communication can be performed without a loss of information, in accordance with whether the transmission capacity C₁ is greater than or equal to the total transmission capacity Cₛ (or a predetermined value based on Cₛ) of the transmitting station devices 101 indicated by a dotted line 150, or is smaller than that.

For example, in FIG. 4, the transmission capacity C₁ in a period T₁ from time t₁ to time t₂ and a period T₂ from time t₃ to time t₄ is greater than or equal to the total transmission capacity Cₛ of the transmitting station devices 101, and thus communication can be performed in these periods. However, the transmission capacity C₁ in a period from the time t₂ to the time t₃ is smaller than the total transmission capacity Cₛ of the transmitting station devices 101, and thus, there is a possibility that information is lost in this period.

The receiving relay station device 102 according to the present embodiment notifies in advance, using a control signal, the transmitting station devices 101 of time periods that satisfies the inequality (2) described in the first embodiment as communicable time. With this configuration, the transmitting station devices 101 transmit data signals only during the communicable time notified by the receiving relay station device 102, and thus, the data signals can be transmitted without a loss of information from the receiving relay station device 102 to the receiving station device 103. Note that the receiving relay station device 102 may notify the transmitting station devices 101 of time periods that satisfy the inequality (3) described in the first embodiment as a non-communicable time (communication stop time). In this case, the transmitting station devices 101 transmit the data signals to the receiving relay station device 102 during a time period other than the communication stop time.

Thus, in the above-described manner, in the radio system 100 according to the second embodiment, the transmitting station devices 101 are notified of time periods during which the transmission capacity between the receiving relay station device 102 and the receiving station device 103 is greater than or equal to the total transmission capacity of the plurality of transmitting station devices 101 as the communicable time, and therefore, the receiving relay station device 102 can transmit the data signals of the plurality of transmitting station devices 101 to the receiving station device 103 without a loss of information. In particular, in the radio system 100 according to the second embodiment, the communication permission notification and the communication stop notification do not need to be transmitted every time the state switches between those indicated by the equation (1) and the inequality (2) as in the radio system 100 according to the first embodiment, and thus, the processing load of the receiving relay station device 102 is reduced.

[Third Embodiment]

Next, the radio system 100 according to the third embodiment will be described. The third embodiment is an embodiment of the radio system 100 suitable for the case where the receiving relay station device 102 periodically moves as in the radio system 100 according to the second embodiment, and the case where the transmitting station devices 101 are dispersed. In the present embodiment, since the transmitting station devices 101 are dispersed, the plurality of transmitting station devices 101 are grouped in each of a plurality of areas, and the receiving relay station device 102 controls the transmitting station devices 101 for each area. The receiving relay station device 102 then notifies, using control signals, the transmitting station devices 101 in each area of the communicable time for the area.

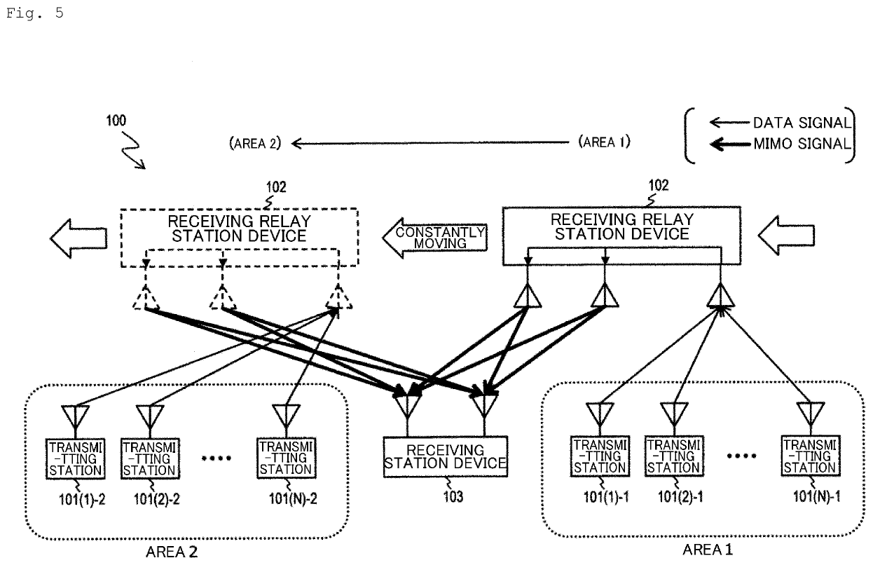

FIG. 5 shows an example of the radio system 100 according to the third embodiment. In the example in FIG. 5, the receiving relay station device 102 moves from an area 1 to an area 2. In the area 1, a transmitting station device 101 (1)-1, a transmitting station device 101 (2)-1, . . . , and a transmitting station device 101(N)−1 are grouped, and in the area 2, a transmitting station device 101(1)−2, a transmitting station device 101(2)−2, . . . , and a transmitting station device 101 (N)−2 are grouped. Here, “−1” following the reference numeral indicates the area 1, and “−2” indicates the area 2.

In FIG. 5, when the receiving relay station device 102 is in the area 1, the receiving relay station device 102 receives data signals from the transmitting station devices 101 in the area 1 (which will be referred to as transmitting station devices 101-1), and transmits the received data signals to the receiving station device 103. Similarly, when the receiving relay station device 102 is in the area 2, the receiving relay station device 102 receives data signals from the transmitting station devices 101 in the area 2 (which will be referred to as transmitting station devices 101-2), and transmits the received data signals to the receiving station device 103.

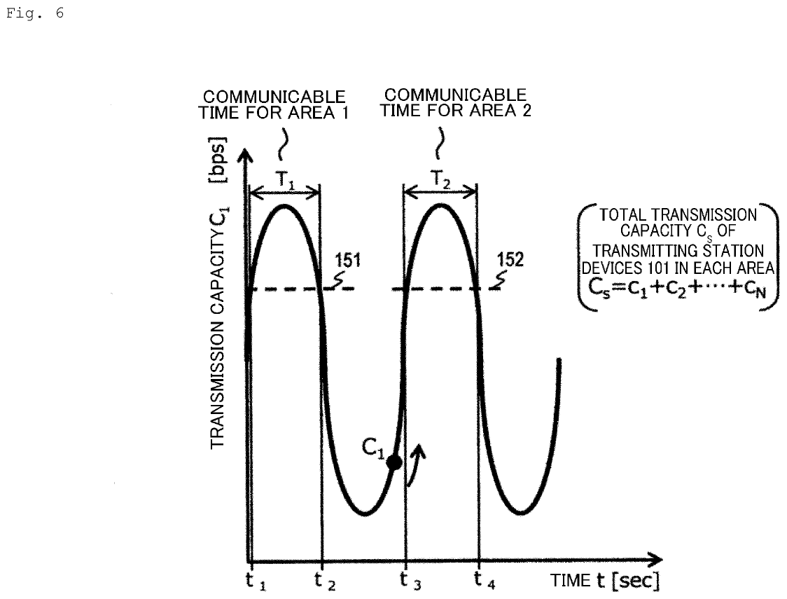

FIG. 6 indicates an example of variations in the transmission capacity C₁ of the receiving relay station device 102 according to the third embodiment. Note that FIG. 6 is a diagram similar to FIG. 4, and the horizontal axis and the vertical axis indicate time t [sec] and the transmission capacity C₁ [bps] from the receiving relay station device 102 to the receiving station device 103, respectively.

Since the receiving relay station device 102 is constantly moving in a periodic orbit, the transmission capacity C₁ between the receiving relay station device 102 and the receiving station device 103 varies as shown in FIG. 6. Here, similarly to the second embodiment, the receiving relay station device 102 can determine whether or not communication can be performed without a loss of information, in accordance with whether the transmission capacity C₁ is greater than or equal to the total transmission capacity Cₛ (or a predetermined value based on Cₛ) of the transmitting station device 101, or is smaller than that. Note that a dotted line 151 indicates the total transmission capacity Cₛ (Cₛ i) of the transmitting station devices 101 in the area 1, and a dotted line 152 indicates the total transmission capacity Cₛ (Cₛ₂) of the transmitting station devices 101 in the area 2. Here, Cₛ₁ and CCₛ₂ may be different since there are cases where the number of transmitting station devices 101 and the information volume transmitted are different between the areas. Note that the transmission capacity of each transmitting station device 101 in each area is fixed, and the total transmission capacities Cₛ (Cₛ₁ and Cₛ₂) of the plurality of transmitting station devices 101 in the respective areas do not change.

In FIG. 6, the transmission capacity C₁ is greater than or equal to the total transmission capacity Cₛ₁ of the transmitting station devices 101-1 in the area 1 during a period T₁ from time t₁ to time t₂, and therefore the period T₁ is set as communicable time for the area 1. Also, the transmission capacity C₁ is greater than or equal to the total transmission capacity CCₛ₂ of the transmitting station devices 101-2 in the area 2 during a period T₂ from time t₃ to time t₄, and therefore the period T₂ is set as communicable time for the area 2.

Here, the receiving relay station device 102 may notify the transmitting station devices 101 of a time period during which the transmission capacity increases within a time period during which the receiving relay station device 102 is approaching each area, as communicable time for this area.

Thus, the receiving relay station device 102 according to the third embodiment notifies the transmitting station devices 101 in each area of the communicable time. With this configuration, the transmitting station devices 101 in each area can transmit data signals during the communicable time, and the receiving relay station device 102 can transmit the data signals of the transmitting station devices 101 in this area to the receiving station device 103 without a loss of information.

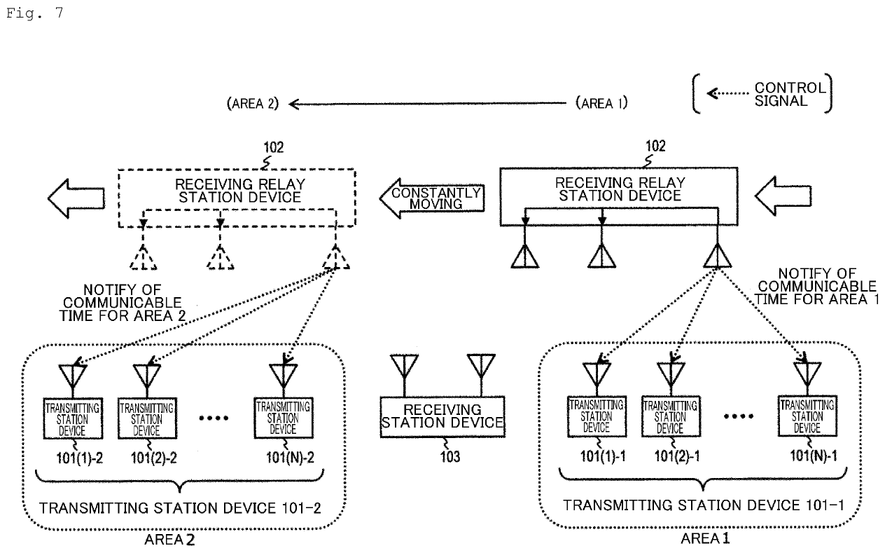

FIG. 7 shows the receiving relay station device 102 notifying each area of the communicable time. Note that in FIG. 7, which corresponds to FIG. 5 described above, the receiving relay station device 102 notifies, using a control signal, the transmitting station devices 101-1 in the area 1 of the communicable time when passing through the area 1, and notifies, using a control signal, the transmitting station devices 101-2 in the area 2 of the communicable time when passing through the area 2. With this configuration, even if a plurality of transmitting station devices 101 are installed in a plurality of areas with different communicable time, the transmitting station devices 101 in each area transmit data signals during the communicable time notified by the receiving relay station device 102. As a result, the receiving relay station device 102 can transmit the data signals of the transmitting station devices 101 in each area to the receiving station device 103 without a loss of information.

[Fourth Embodiment]

Next, the radio system 100 according to the fourth embodiment will be described. In the radio system 100 according to the fourth embodiment, a plurality of receiving relay station devices 102 are operated, and each of the receiving relay station devices 102 notifies the transmitting station devices 101 of the communicable time. The transmitting station devices 101 transmit data signals while switching the receiving relay station device 102 to which the data signals are transmitted, in accordance with the time period.

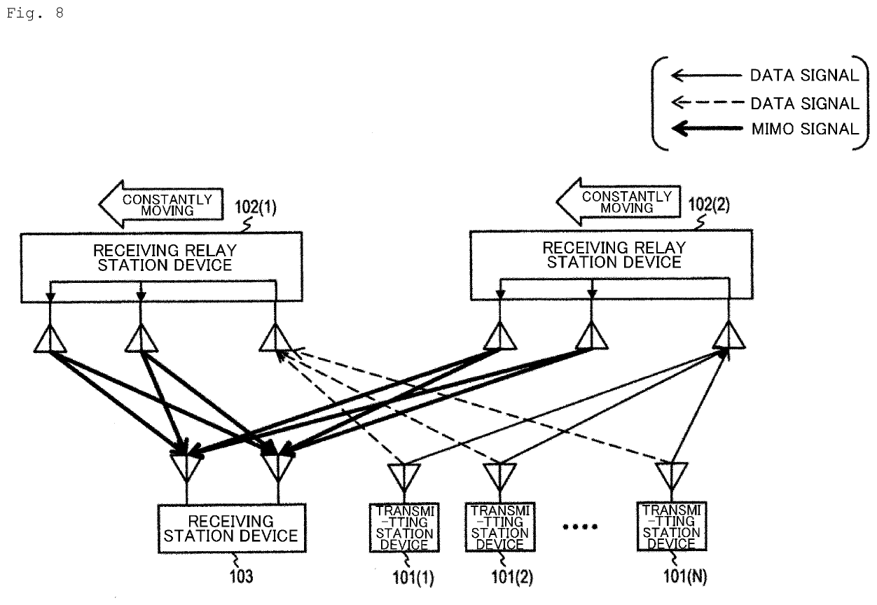

FIG. 8 shows an example of the radio system 100 according to the fourth embodiment. In FIG. 8, the radio system 100 according to the present embodiment has two receiving relay station devices 102, namely a receiving relay station device 102(1) and a receiving relay station device 102(2), and these receiving relay station devices 102 are constantly moving. The transmitting station devices 101 transmit data signals to the receiving relay station device 102(1) at the time when the receiving relay station device 102(1) can communicate, and transmits data signals to the receiving relay station device 102(2) at the time when the receiving relay station device 102(2) can communicate. Note that in FIG. 8, it appears that the transmission of data signals from the transmitting station devices 101 to the receiving relay station device 102(1) indicated by thin solid arrows and the transmission of data signals from the transmitting station devices 101 to the receiving relay station device 102 (2) indicated by broken arrows are performed at the same time, but the time period during which the transmitting station devices 101 transmit the data signals is different.

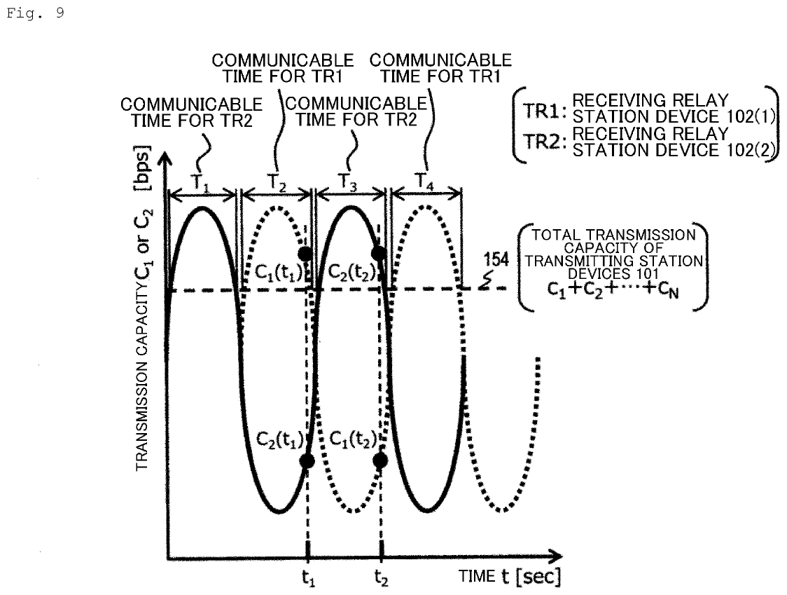

FIG. 9 shows an example of variations in the transmission capacity of the two receiving relay station devices 102. In FIG. 9, a dotted line indicates variations in the transmission capacity of the receiving relay station device 102(1), and a solid line indicates variations in the transmission capacity of the receiving relay station device 102(2). Note that FIG. 9 is a diagram similar to FIGS. 6 and 4, and the horizontal axis and the vertical axis respectively indicate time t [sec] and the transmission capacity C₁ or C₂ [bps] from the receiving relay station device 102(1) or the receiving relay station device 102(2) to the receiving station device 103. Here, in FIG. 9, the receiving relay station device 102(1) is denoted as TR1, and the receiving relay station device 102(2) is denoted as TR2.

Since the receiving relay station device 102(1) or the receiving relay station device 102(2) are constantly moving in respective periodic orbits, the transmission capacities C₁ and C₂ between the receiving relay station device 102(1) and the receiving station device 103 and between the receiving relay station device 102 (2) and the receiving station device 103 vary differently as shown in FIG. 9. Here, similarly to second and third embodiments, the receiving relay station device 102(1) and the receiving relay station device 102(2) can determine whether or not communication can be performed without a loss of information, in accordance with whether the transmission capacities C₁ and C₂ are greater than or equal to the total transmission capacity Cₛ (or a predetermined value based on Cₛ) of the transmitting station devices 101 indicated by a dotted line 154, or are smaller than that, respectively. Here, the transmission capacity C₁ between the receiving relay station device 102 (1) and the receiving station device 103 may be different from the transmission capacity C₂ between the receiving relay station device 102 (2) and the receiving station device 103. Note that it is assumed that the transmission capacity of each transmitting station device 101 is fixed, and the total transmission capacity Cₛ of the plurality of transmitting station devices 101 does not change.

In FIG. 9, during periods T₁ and T₃, the transmission capacity C₂ of the receiving relay station device 102 (2) is greater than or equal to the total transmission capacity Cₛ of the transmitting station devices 101, thus the transmitting station devices 101 can communicate with the receiving relay station device 102(2), and these periods are set as the communicable time for the receiving relay station device 102(2). During periods T₂ and T₄, the transmission capacity C₁ of the receiving relay station device 102(1) is greater than or equal to the total transmission capacity Cₛ of the transmitting station devices 101, thus the transmitting station devices 101 can communicate with the receiving relay station device 102(1), and these periods are set as the communicable time for the receiving relay station device 102(1).

For example, at time ti, the receiving relay station device 102(1) cannot perform communication since the transmission capacity C₁ of the receiving relay station device 102 (1) is smaller than the total transmission capacity Cₛ of the transmitting station devices 101, but the transmission capacity C₂ of the receiving relay station device 102 (2) is greater or equal to the total transmission capacity Cₛ of the transmitting station devices 101. Thus, the transmitting station devices 101 transmit data signals to the receiving relay station device 102(2). Conversely, at time t₂, the receiving relay station device 102(2) cannot perform communication since the transmission capacity C₂ of the receiving relay station device 102 (2) is smaller than the total transmission capacity Cₛ of the transmitting station devices 101, but the transmission capacity C₁ of the receiving relay station device 102 (1) is greater than or equal to the total transmission capacity Cₛ of the transmitting station devices 101. Thus, the transmitting station devices 101 transmit data signals to the receiving relay station device 102(1).

Thus, in the fourth embodiment, the receiving relay station device 102(1) and the receiving relay station device 102(2) notify, in advance, the transmitting station devices 101 of the respective communicable time, and thus the transmitting station devices 101 can transmit data signals while switching the receiving relay station device 102 to which the data signals are transmitted, in accordance with the communicable time.

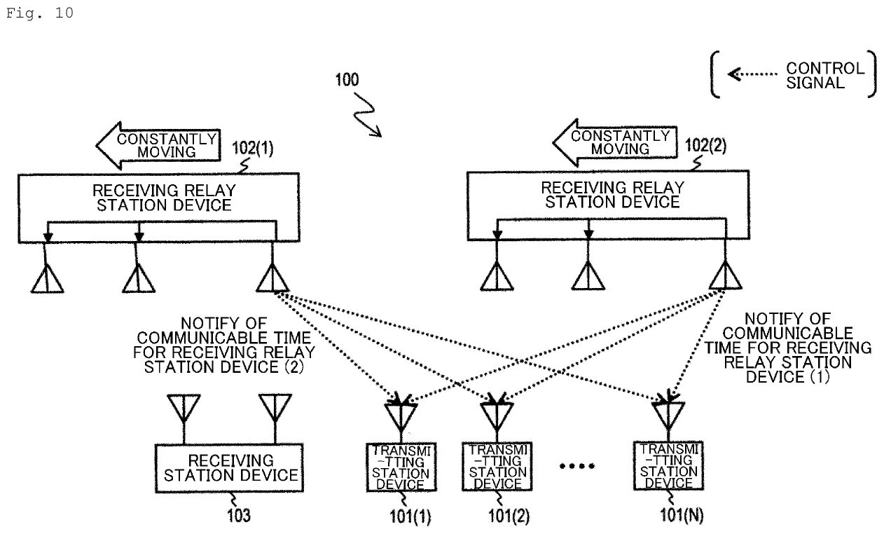

FIG. 10 shows the plurality of receiving relay station devices 102 notifying of the respective communicable time. Note that in FIG. 10, which corresponds to FIG. 8 described above, the receiving relay station device 102(1) and the receiving relay station device 102(2) notify, using control signals, the transmitting station devices 101 of the respective communicable time. With this configuration, the transmitting station devices 101 can transmit data signals while switching the receiving relay station device 102 to which the data signals are transmitted, in accordance with the communicable time. Therefore, the receiving relay station device 102(1) and the receiving relay station device 102 (2) can transmit the data signals received from the transmitting station devices 101 to the receiving station device 103 without a loss of information.

Here, as a method for the transmitting station devices 101 to send data signals to different receiving relay station devices 102, for example, it is conceivable to use the FDMA (Frequency Division Multiple Access) method, in which different frequency bands are allocated to the respective receiving relay station devices 102, or the CDMA (Code Division Multiple Access) method, in which different codes are allocated in the spread spectrum method.

[Configuration of Transmitting Station Device 101]

Next, an example configuration of the transmitting station device 101 common to the above embodiments will be described.

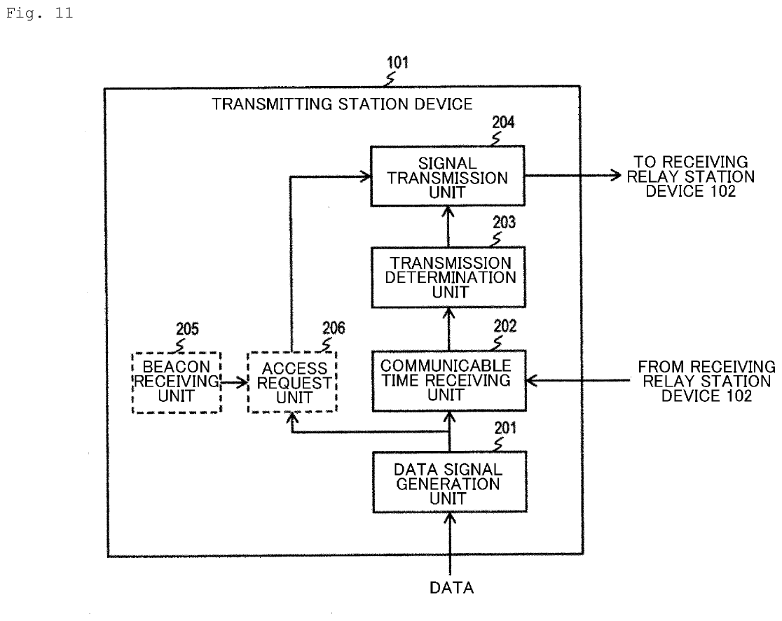

FIG. 11 shows an example configuration of the transmitting station device 101. The transmitting station device 101 has a data signal generation unit 201, a communicable time receiving unit 202, a transmission determination unit 203, a signal transmission unit 204, a beacon receiving unit 205, and an access request unit 206.

The data signal generation unit 201 generates a data signal to be transmitted to receiving station device 103 via the receiving relay station device 102. For example, if the transmitting station device 101 is the sensor terminal 101 described with reference to FIG. 2, the transmitting station device 101 receives input of data containing sensed environmental information, such as air temperature, room temperature, acceleration, and luminosity, from an external sensor or the like, and generates a data signal.

The communicable time receiving unit 202 receives a control signal containing the communicable time from the receiving relay station device 102.

The transmission determination unit 203 determines whether or not to transmit the data signal generated by the data signal generation unit 201 to the receiving relay station device 102, based on the communicable time notified by the receiving relay station device 102. Here, the transmitting station device 101 contains a clock function, and the transmission determination unit 203 instructs the signal transmission unit 204 to transmit the data signal when the communicable time is reached. Note that in the case of the radio system 100 according to the first embodiment, the transmission determination unit 203 instructs the signal transmission unit 204 to transmit the data signal or stop transmitting the data signal based on the communication permission notification or the communication stop notification given by means of a control signal from the receiving relay station device 102.

The signal transmission unit 204 transmits the data signal generated by the data signal generation unit 201 to the receiving relay station device 102 in accordance with the instruction from the transmission determination unit 203. The signal transmission unit 204 also transmits, to the receiving relay station device 102, a control signal that contains a request to access the receiving relay station device 102 and the transmission capacity of the data signal, in accordance with an instruction from the later-described access request unit 206.

The beacon receiving unit 205 monitors a beacon that is constantly transmitted by the receiving relay station device 102 and checks the presence of the receiving relay station device 102 to which the data signal is to be transmitted. Note that the beacon is a simple narrow-band signal.

The access request unit 206 instructs the signal transmission unit 204 to transmit a control signal for making an access request to the receiving relay station device 102 checked by the beacon receiving unit 205.

Thus, the transmitting station device 101 can receive the control signal for notifying the communicable time from the receiving relay station device 102 and transmit the data signal during the communicable time. Alternatively, in the case of the radio system 100 according to the first embodiment, the transmitting station device 101 can transmit the data signal or stop transmitting the data signal based on the communication permission notification or the communication stop notification given by means of the control signal from the receiving relay station device 102.

[Configuration of Receiving Relay Station Device 102]

Next, an example configuration of the receiving relay station device 102 common to the above embodiments will be described.

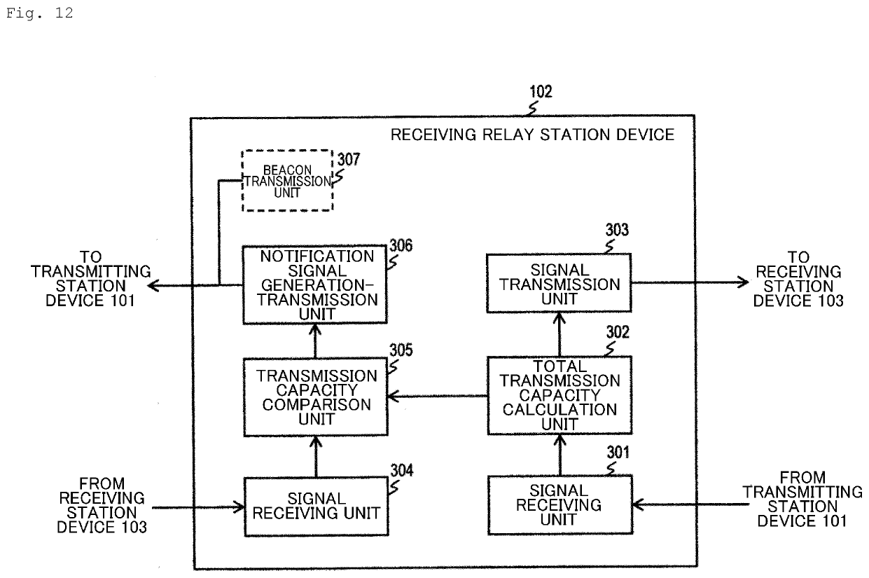

FIG. 12 shows an example configuration of the receiving relay station device 102. The receiving relay station device 102 has a signal receiving unit 301, a total transmission capacity calculation unit 302, a signal transmission unit 303, a signal receiving unit 304, a transmission capacity comparison unit 305, a notification signal generation-transmission unit 306, and a beacon transmission unit 307.

The signal receiving unit 301 receives the control signal that contains the access request and the transmission capacity of the data signal from the transmitting station device 101. The signal receiving unit 301 also receives the data signal transmitted from the transmitting station device 101 during the communicable time. Note that the communication between the receiving relay station device 102 and the plurality of transmitting station devices 101 is multiple-access communication using a predetermined method such that data signals do not collide with each other.

The total transmission capacity calculation unit 302 calculates the total transmission capacity of all the transmitting station devices 101 based on the control signal that contains the access request and the transmission capacity of the data signal that the signal receiving unit 301 receives from the transmitting station devices 101, and outputs the calculated total transmission capacity to the transmission capacity comparison unit 305. During a data signal relay operation, the total transmission capacity calculation unit 302 receives input of the data signal received by the signal receiving unit 301 from the transmitting station device 101, outputs the input data signal as-is to the signal transmission unit 303, and the data signal is transmitted from the signal transmission unit 303 to the receiving station device 103 (relay of the data signal).

The signal transmission unit 303 transmits the data signal input from the total transmission capacity calculation unit 302, to the receiving station device 103 using the MIMO method. The signal transmission unit 303 also transmits, to the receiving station device 103, a pilot signal for calculating the transmission capacity between the receiving relay station device 102 and the receiving station device 103.

The signal receiving unit 304 receives, from the receiving station device 103, a control signal for notifying the transmission capacity between the receiving station device 103 and the receiving relay station device 102 that is calculated by the receiving station device 103.

The transmission capacity comparison unit 305 compares the transmission capacity C between the receiving station device 103 and the receiving relay station device 102 received by the signal receiving unit 304 with the total transmission capacity Cₛ of the plurality of transmitting station devices 101 calculated by the total transmission capacity calculation unit 302. The transmission capacity comparison unit 305 then sets a time period that satisfies C≥Cₛ as the communicable time, and outputs the set communicable time to the notification signal generation-transmission unit 306. Note that in the case of the third embodiment, the communicable time is set for each area.

The notification signal generation-transmission unit 306 generates a signal (control signal) for notifying the transmitting station device 101 of the communicable time during which the transmitting station device 101 can transmit the data signal to the receiving relay station device 102, and transmits the generated signal to the transmitting station device 101. Note that in the case of the third embodiment, the notification signal generation-transmission unit 306 generates and transmits a control signal for notifying the communicable time for each area to the transmitting station devices 101 in the area. In the case of the first embodiment, the notification signal generation-transmission unit 306 transmits the communication permission notification to the transmitting station device 101 using a control signal when the state has changed from C<Cₛ to C≥Cₛ, and transmits the communication stop notification to the transmitting station device 101 using a control signal when the state has changed from C≥Cₛ to C<Cₛ.

The beacon transmission unit 307 constantly transmits a predetermined beacon for notifying the transmitting station device 101 of the presence of the receiving relay station device 102.

Thus, the receiving relay station device 102 compares, based on the beacon, the total transmission capacity Cₛ notified by the plurality of transmitting station devices 101 with the transmission capacity C between the receiving relay station device 102 and the receiving station device 103 that is notified by the receiving station device 103, and notifies the transmitting station device 101 of a time period that satisfies C≥Cₛ as the communicable time. Alternatively, in the case of the first embodiment, the receiving relay station device 102 transmits the communication permission notification or the communication stop notification to the transmitting station device 101 when the state has changed between C<Cₛ and C≥Cₛ. With this configuration, the transmitting station device 101 can transmit the data signal during the communicable time, and therefore, the receiving relay station device 102 can transmit data signals received from the plurality of transmitting station devices 101 to the receiving station device 103 without a loss of information, even if the transmission capacity between the receiving relay station device 102 and the receiving station device 103 varies.

[Configuration of Receiving Station Device 103]

Next, an example configuration of the receiving station device 103 common to the above embodiments will be described.

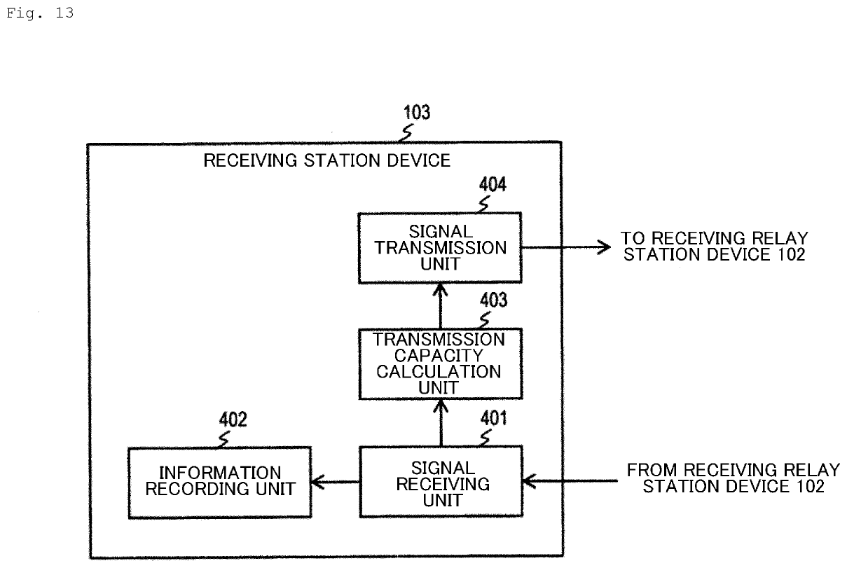

FIG. 13 shows an example configuration of the receiving station device 103. The receiving station device 103 has a signal receiving unit 401, an information recording unit 402, a transmission capacity calculation unit 403, and a signal transmission unit 404.

The signal receiving unit 401 receives the data signal of the transmitting station device 101 that is relayed by the receiving relay station device 102. The signal receiving unit 401 also receives the pilot signal transmitted by the receiving relay station device 102.

The information recording unit 402 records information regarding the plurality of transmitting station devices 101 included in the data signals of the transmitting station devices 101 that the signal receiving unit 401 receives from the receiving relay station device 102. For example, in the case of FIG. 2, the information recording unit 402 records environmental information such as air temperature, room temperature, acceleration, and luminosity sensed by the sensor terminal 101, together with device information (position information, identification information etc.) regarding the sensor terminal 101, in a storage medium such as a semiconductor memory or a hard disk.

The transmission capacity calculation unit 403 calculates the transmission capacity between the receiving relay station device 102 and the receiving station device 103. Note that the transmission capacity is calculated using the existing pilot signal transmitted from the receiving relay station device 102.

The signal transmission unit 404 transmits, to the receiving relay station device 102, a control signal containing information of the transmission capacity between the receiving relay station device 102 and the receiving station device 103 that is calculated by the transmission capacity calculation unit 403.

Thus, the receiving station device 103 calculates the transmission capacity between the receiving station device 103 and the receiving relay station device 102 using the pilot signal received from the receiving relay station device 102, and transmits the calculated transmission capacity to the receiving relay station device 102. With this configuration, the receiving station device 103 can receive the data signals that are transmitted from the plurality of transmitting station devices 101 during the communicable time and relayed by the receiving relay station device 102 without a loss of information, and record the received data signal in the information recording unit 402.

[Operation Sequence of Radio System 100]

Next, an operation sequence of the radio system 100 that is common to the above-described second, third, and fourth embodiments will be described. Note that since the receiving relay station device 102 is a low earth orbit satellite in the second, third, and fourth embodiments, the communicable time (or time period) is periodic, and the communicable time can be preset in the transmitting station device 101.

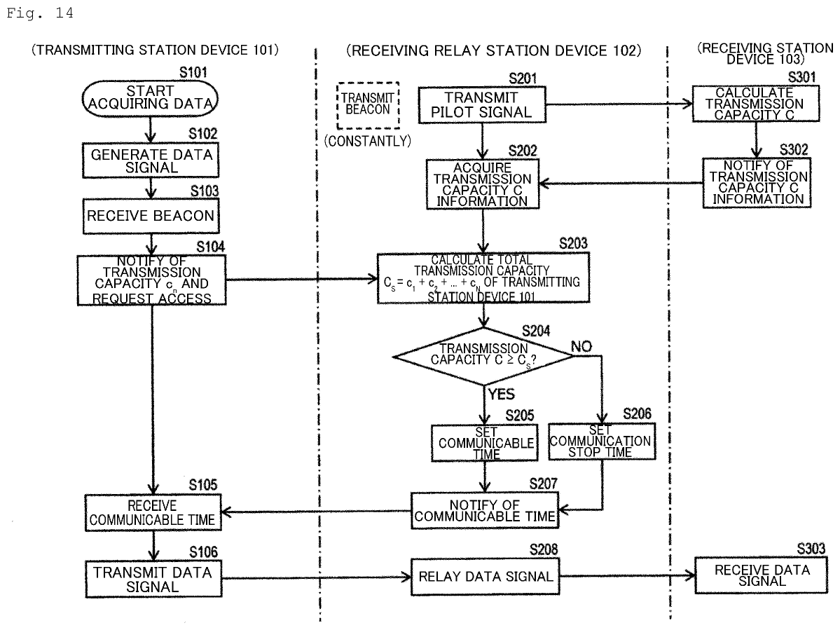

FIG. 14 shows an example of the operation sequence of the radio system 100. Note that in the case of the radio system 100 according to the third embodiment, the operation sequence in FIG. 14 is executed for each area. In the case of the radio system 100 according to the fourth embodiment, the operation sequence in FIG. 14 is executed for each of the plurality of receiving relay station devices 102.

First, the operation sequence of the transmitting station device 101 will be described. Note that the following processing is executed by the blocks of the transmitting station device 101 described with reference to FIG. 11.

In step S101, the data signal generation unit 201 starts acquiring data to be transmitted to the receiving station device 103 via the receiving relay station device 102. For example, if the transmitting station device 101 is the sensor terminal 101, data such as air temperature, room temperature, acceleration, and luminosity is acquired.

In step S102, the data signal generation unit 201 generates the data signal to be transmitted to the receiving relay station device 102, based on the data acquired in step S101.

In step S103, the beacon receiving unit 205 receives the beacon that is constantly transmitted from the receiving relay station device 102. The transmitting station device 101 checks the presence of the receiving relay station device 102 by receiving the beacon.

Instep S104, the access request unit 206 checks the presence of the receiving relay station device 102 due to the beacon receiving unit 205 receiving the beacon, and transmits, to the receiving relay station device 102, the control signal that contains a notification of the transmission capacity cₙ (n is an integer from 1 to N) of the data signal and the access request.

In step S105, the communicable time receiving unit 202 receives the control signal for notifying the communicable time from the receiving relay station device 102. Note that in the case of the first embodiment, the communicable time receiving unit 202 receives the control signal of the communication permission notification or the communication stop notification from the receiving relay station device 102.

In step S106, the transmission determination unit 203 determines whether or not to transmit the data signal to the receiving relay station device 102 based on the communicable time notified by the receiving relay station device 102, and instructs the signal transmission unit 204 to transmit the data signal when the communicable time is reached. Note that in the case of the first embodiment, the transmission determination unit 203 instructs the signal transmission unit 204 to transmit the data signal or stop transmitting the data signal based on the communication permission notification or the communication stop notification notified by the receiving relay station device 102.

Thus, the transmitting station device 101 notifies the receiving relay station device 102 of the transmission capacity of the data signal, and transmits the data signal based on the communicable time (or the communication permission notification/communication stop notification) notified by the receiving relay station device 102.

Next, the operation sequence of the receiving relay station device 102 will be described. The following processing is executed by the blocks of the receiving relay station device 102 described with reference to FIG. 12. Note that the beacon transmission unit 307 of the receiving relay station device 102 constantly transmits a beacon for notifying the transmitting station device 101 of the presence of the receiving relay station device 102.

In step S201, the signal transmission unit 303 transmits the pilot signal to the receiving station device 103.

In step S202, the signal receiving unit 304 receives the control signal containing the transmission capacity between the receiving station device 103 and the receiving relay station device 102 that is calculated by the receiving station device 103 (acquisition of information of transmission capacity C).

In step S203, the total transmission capacity calculation unit 302 calculates the total transmission capacity Cₛ using the above-described equation (1) based on the transmission capacity cₙ of the data signals that the signal receiving unit 301 receives from the plurality of transmitting station devices 101.

In step S204, the transmission capacity comparison unit 305 compares the transmission capacity C between the receiving station device 103 and the receiving relay station device 102 with the total transmission capacity Cₛ of the plurality of transmitting station device 101. If C Cₛ, processing in step S205 is then performed, and if C<Cₛ, processing in step S206 is then performed.

In step S205, the notification signal generation-transmission unit 306 sets a time period during which C Cₛ as the communicable time.

In step S206, the notification signal generation-transmission unit 306 sets a time period during which C <Cₛ as the communicable time.

In step S207, the notification signal generation-transmission unit 306 generates the control signal for notifying the transmitting station device 101 of the communicable time set in step S205, and transmits the generated control signal to the transmitting station device 101. Note that in the case of the first embodiment, the notification signal generation-transmission unit 306 transmits the control signal of the communication permission notification or the communication stop notification to the transmitting station device 101 every time the communication stop time switches to the communication-permitted time or the communicable time switches to the communication stop time, based on step S205 or step S206.

In step S208, the receiving relay station device 102 relays the data signal that the signal receiving unit 301 receives from the transmitting station device 101, and transmits the data signal from the signal transmission unit 303 to the receiving station device 103.

Thus, the receiving relay station device 102 acquires information of the transmission capacity C between the receiving relay station device 102 and the receiving station device 103 based on the pilot signal, compares, based on the beacon, the total transmission capacity Cₛ notified by the plurality of transmitting station devices 101 with the transmission capacity C, and notifies the transmitting station device 101 of a time period that satisfies C≥Cₛ as the communicable time. Alternatively, in the case of the first embodiment, the receiving relay station device 102 transmits the communication permission notification or the communication stop notification to the transmitting station device 101 every time the state switches from C<Cₛ to C≥Cₛ or from C≥Cₛ to C<Cₛ. With this configuration, since the transmitting station device 101 transmits the data signal during the communicable time, the receiving relay station device 102 can relay the data signal without a loss of information even if the transmission capacity between the receiving relay station device 102 and the receiving station device 103 varies.

Next, the operation sequence of the receiving station device 103 will be described. Note that the following processing is executed by the blocks of the receiving station device 103 described with reference to FIG. 13.

In step S301, the transmission capacity calculation unit 403 receives the pilot signal from the receiving relay station device 102 through the signal receiving unit 401, and calculates the transmission capacity C between the receiving station device 103 and the receiving relay station device 102.

In step S302, the transmission capacity calculation unit 403 transmits the control signal containing information of the transmission capacity C calculated in step S301 from the signal transmission unit 404 to the receiving relay station device 102.

Instep S303, the signal receiving unit 401 receives the data signals of the plurality of transmitting station devices 101 that are relayed by the receiving relay station device 102, and records, in the information recording unit 402, information (e.g., sensing information) regarding the plurality of transmitting station devices 101 contained in the data signals.

Thus, the receiving station device 103 calculates the transmission capacity C between the receiving station device 103 and the receiving relay station device 102 and notifies the receiving relay station device 102 of the calculated transmission capacity C. With this configuration, the receiving station device 103 can receive the data signals transmitted from the plurality of transmitting station devices 101 during the communicable time from the receiving relay station device 102 without a loss of information even of the transmission capacity between the receiving station device 103 and the receiving relay station device 102 varies.

As described in the embodiments above, the radio system 100 according to the present invention controls transmission of the data signal of the transmitting station device 101 in accordance with the variations in the transmission capacity between the receiving relay station device 102 and the receiving station device 103, and can thus prevent a lack of information of the data signal.

### REFERENCE SIGNS LIST

100 Radio system
101 Transmitting station device (sensor terminal)
102 Receiving relay station device (satellite relay station device)
103 Receiving station device (base station device)
201 Data signal generation unit
202 Communicable time receiving unit
203 Transmission determination unit
204 Signal transmission unit
205 Beacon receiving unit
206 Access request unit
301 Signal receiving unit
302 Total transmission capacity calculation unit
303 Signal transmission unit
304 Signal receiving unit
305 Transmission capacity comparison unit
306 Notification signal generation-transmission unit
307 Beacon transmission unit
401 Signal receiving unit
402 Information recording unit
403 Transmission capacity calculation unit
404 Signal transmission unit

1. A radio system comprising:
a plurality of transmitting station devices;
a receiving relay station device for relaying radio signals transmitted by the transmitting station devices; and
a receiving station device for receiving the radio signals relayed by the receiving relay station device, with a first transmission capacity between the receiving relay station device and the receiving station device varying,
wherein
the receiving relay station device performs control to cause the transmitting station devices to transmit the radio signals if the first transmission capacity is greater than or equal to a predetermined value.

2. The radio system according to claim 1, wherein the receiving relay station device calculates a total transmission capacity between the receiving relay station device and the plurality of transmitting station devices as a second transmission capacity, and performs control to cause the transmitting station devices to transmit the radio signals if the first transmission capacity is greater than or equal to the second transmission capacity.

3. The radio system according to claim 1, wherein
if the variation in the transmission capacity between the receiving relay station device and the receiving station device is periodic,
the receiving relay station device notifies the transmitting station devices of communicable time during which the first transmission capacity is greater than or equal to the second transmission capacity, based on a period of the variation, and
the transmitting station devices transmit the radio signals based on the communicable time notified by the receiving relay station device.

4. The radio system according to claim 1, wherein
the receiving relay station device and the receiving station device communicate with each other using a MIMO method in which spatially-multiplexed transmission is performed using a plurality of transmitting-receiving antennas, and the transmission capacity varies in accordance with positions of the antennas of the receiving relay station device that constantly moves and the antennas of the receiving station device.

5. A receiving relay station device that relays radio signals transmitted by a plurality of transmitting station devices and transmits the relayed radio signals to a receiving station device, the receiving relay station device comprising:
a receiving unit for receiving, from the receiving station device, a first transmission capacity between the receiving relay station device and the receiving station device, the first transmission capacity varying; and
a comparison unit for performing control to cause the plurality of transmitting station devices to transmit the radio signals if the first transmission capacity is greater than or equal to a predetermined value.

6. The receiving relay station device according to claim 5, further comprising:
a calculation unit for calculating a total transmission capacity between the receiving relay station device and the plurality of transmitting station devices as a second transmission capacity, and
the comparison unit performs control to cause the transmitting station devices to transmit the radio signals if the first transmission capacity is greater than or equal to the second transmission capacity.

7. A transmission control method for controlling transmission timing of a plurality of transmitting station devices in a radio system in which a receiving relay station device relays radio signals transmitted by the transmitting station devices and transmits the relayed radio signals to a receiving station device, the method comprising
performing control to cause the plurality of transmitting station devices to transmit the radio signals if a first transmission capacity between the receiving relay station device and the receiving station device, the first transmission capacity varying, is greater than or equal to a predetermined value, with use of the receiving relay station device.

8. The transmission control method according to claim 7, further comprising
calculating, as a second transmission capacity, a total transmission capacity between the receiving relay station device and the plurality of transmitting station devices, and performing control to cause the transmitting station devices to transmit the radio signals if the first transmission capacity is greater than or equal to the second transmission capacity, with use of the receiving relay station device.
